(19) United States
(12) Patent Application Publication
(10) Pub. No.: US 2025/0355906 A1
(43) Pub. Date: Nov. 20, 2025

(54) FINE-TUNING LARGE LANGUAGE MODELS

(71) Applicant: Airbnb, Inc., San Francisco, CA (US)

(72) Inventors: Hanchen Su, Mountlake Terrace, WA (US); Cen Mia Zhao, Foster City, CA (US); Yashar Mehdad, Redwood City, CA (US); Ying Zhang, Palo Alto, CA (US); Wei Han, Redwood City, CA (US); Yu Liu, Foster City, CA (US); Wei Luo, Beijing (CN); Shengquan Yan, Seattle, WA (US); Yufeng Zhang, Redmond, WA (US)

(21) Appl. No.: 19/210,421

(22) Filed: May 16, 2025

Related U.S. Application Data
(60) Provisional application No. 63/649,217, filed on May 17, 2024.

(51) Int. Cl. G06F 16/3329

(52) U.S. Cl. CPC G06F 16/3329

(57) ABSTRACT

Various aspects of the subject technology relate to systems, methods, and machine-readable media for tuning a Large Language Model. Various aspects may include receiving a query from a user; in response to the query, identifying a workflow of a plurality of workflows. Aspects may also include extracting from the workflow: at least one intent parameter, at least one context parameter, and at least one action parameter. Aspects may also include providing the at least one intent parameter, the at least one context parameter, and the at least one action parameter to the LLM structured in the coding syntax for use by the LLM. Aspects may also include retrieving contextual data from an application programming interface (API) associated with the query. Aspects may also include tuning the LLM, wherein tuning the LLM comprises training the LLM with synthetic training data; and providing an action item to a user via the LLM.

### CROSS-REFERENCE TO RELATED APPLICATIONS

The present disclosure is related and claims priority under 35 U.S.C. § 119(e) to U.S. Provisional Patent Application No. 63/649,217, entitled FINE-TUNING LARGE LANGUAGE MODELS to Hanchen Su, et al., filed on May 17, 2024, the contents of which are hereby incorporated by reference in their entirety, for all purposes.

### TECHNICAL FIELD

The present disclosure generally relates to converting natural language to structured language and, more particularly, fine tuning variance in the structured language.

### BACKGROUND

Customer service responses within logistics can require extended response time and manpower to effectively service a platform. Further, customer service features may be integrated into a platform that uses query interfaces and/or chat bots to initiate inquiries from customers or clients seeking resolution. After an inquiry is received from the client or customer, a human customer service representative may be called on using their judgement to generate a solution based on rules and policies predetermined from a business operating through the platform. The interaction with the human customer service representative generates a lag that reduces productivity and reduces customer satisfaction with the business operating through the platform.

### BRIEF SUMMARY

The subject disclosure provides for systems and methods for improving the quality of search results in an online platform (for example, an online reservation platform). According to one embodiment of the present disclosure, a computer-implemented method for tuning an LLM in a platform is provided. The method includes receiving a query from a user. The method includes in response to the query, identifying a workflow of a plurality of workflows. The method includes extracting from the workflow: at least one intent parameter, at least one context parameter, and at least one action parameter. The method includes providing the at least one intent parameter, the at least one context parameter, and the at least one action parameter to the LLM structured in the coding syntax for use by the LLM. The method includes retrieving contextual data from an application programming interface (API) associated with the query. The method includes tuning the LLM, wherein tuning the LLM comprises training the LLM with synthetic training data. The method also includes providing an action item to a user via the LLM.

According to one embodiment of the present disclosure, a system is provided including a processor and a memory comprising instructions stored thereon, which when executed by the processor, causes the processor to: receive a query from a user; in response to the query, identify a workflow of a plurality of workflows; extract from the workflow: at least one intent parameter, at least one context parameter, and at least one action parameter; provide the at least one intent parameter, the at least one context parameter, and the at least one action parameter to the LLM structured in the coding syntax for use by the LLM; retrieve contextual data from an application programming interface (API) associated with the query; tune the LLM, wherein tuning the LLM comprises training the LLM with synthetic training data; and provide an action item to a user via the LLM.

According to one embodiment of the present disclosure, a non-transitory computer-readable storage medium is provided including instructions (for example, stored sequences of instructions) that, when executed by a processor, cause the processor to receive a query from a user; in response to the query, identify a workflow of a plurality of workflows; extract from the workflow: at least one intent parameter, at least one context parameter, and at least one action parameter; provide the at least one intent parameter, the at least one context parameter, and the at least one action parameter to the LLM structured in the coding syntax for use by the LLM; retrieve contextual data from an application programming interface (API) associated with the query; tune the LLM, wherein tuning the LLM comprises training the LLM with synthetic training data; and provide an action item to a user via the LLM.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To easily identify the discussion of any particular element or act, the most significant digit or digits in a reference number refer to the figure number in which that element is first introduced.

FIG. 1 illustrates a network architecture used to tune Large Language model results and user experience on a platform, according to some embodiments.

FIG. 2 is a block diagram illustrating details of devices used in the architecture of FIG. 1, according to some embodiments.

FIG. 3 is a screenshot of a workflow used by a customer service representative.

FIG. 4 is a depiction of a process diagram transitioning a workflow to a pseudocode to a resultant action item.

FIG. 5 is a block diagram depicting prediction of parameters to enter an LLM and the integration of a tuning mechanism on an LLM model to yield an action item.

FIG. 6 is a block diagram depicting the generation of datasets for use in tuning the LLM.

FIG. 7 is a block diagram illustrating an example system, according to certain aspects of the present disclosure.

FIG. 8 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a thorough understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Large Language Model (LLM) technology is widely used in customer service portals of online businesses. For example, a customer who is seeking assistance may make an inquiry in the service platform using a natural language inquiry, such as, “How do I open the door because the provide code is not working.” This natural language inquiry requires processing through the service portal of an online business. In current embodiments, the response may require a human customer service representative to respond to the inquiry using a structured triage set of rules or policies, wherein the interpretation of the rules or policies are constrained by the customer service representative's training.

For example, when a customer is searching for an answer to a question, the phrasing of the question can query a response from a plurality of workflows. These workflows can comprise courses of action or follow-up questions to address the customer's initial query. In the current state of models, the logic reasoning model has to verify each workflow in a list to see if the workflow matches the user's intention and context. Ultimately, the model must select the correct matched workflow. Nevertheless, executing the model remains challenging for a large language model (LLM) to understand the intricate workflow documents due to the abundance of irrelevant content and an unclear logic reasoning process in each document.

The current disclosure expedites a customer service experience by replacing the response provided by a human customer service representative with a response comprising a combination of a LLM and an interpreter module to efficiently and effectively convert natural language to a structured language. The current discloser further overcomes the technical problem of latency normally associated with LLM application program interfaces. In response to the problem, LLMs are used to reformat a workflow into a fixed format of a transparent reasoning process. Further, the LLM can be used to generate a knowledge base from previously stored internal conversation and application programming interface (API) data. The knowledge base can serve as the basis to generate a correlation between the original conversation/query from the customer and their anticipated meaning. Several implementations are discussed below in more detail in reference to the figures.

While some examples of the disclosure are specific to an online query platform, it will be understood and appreciated by those of ordinary skill in the art that the search improvement features described herein may be applied to other platforms including a search interface. The scope of the disclosure is not limited to the specific embodiments described, but rather extends to any modifications and variations that fall within the scope and knowledge of those skilled in the art.

In particular embodiments, privacy policies may limit the types of user data that may be collected, used, or shared by particular processes of the platform or other processes (for example, internal research, ranking algorithms, machine-learning algorithms) for a particular purpose. The platform may present users with an interface indicating the particular purpose for which user data is being collected, used, or shared. The privacy policies may ensure that only necessary and relevant user data is being collected, used, or shared for the particular purpose, and may prevent such user data from being collected, used, or shared for unauthorized purposes.

### Example Architecture

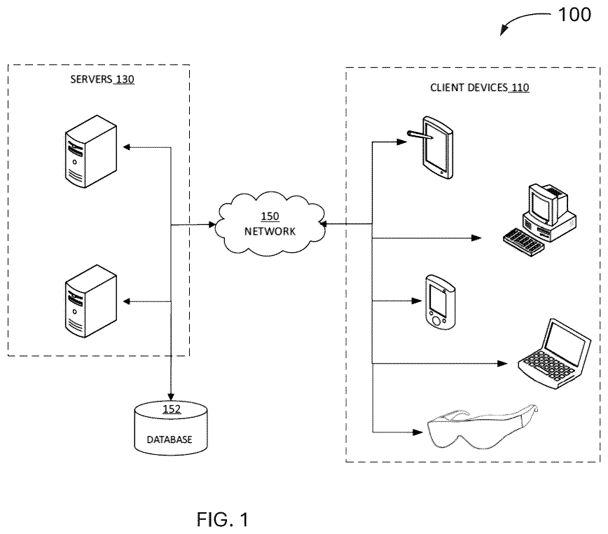

FIG. 1 illustrates a network architecture 100 used to tune LLM(s) to improve the user experience on a platform, according to some embodiments. Architecture 100 may include server(s) 130 and a database 152, communicatively coupled with one or more client devices 110 via a network 150.

Client devices 110 may include any one of a laptop computer, a desktop computer, or a mobile device such as a smart phone, a handheld device, video player, or a tablet device. Client devices 110 include a user interface that allows the user to interact with the platform. Client devices 110 may be configured with a web browser or a dedicated application to facilitate communication with servers 130.

Servers 130 may include a computing device or a cluster of computing devices that host the platform, service, or application running on client devices 110 used by one or more of the participants in the network. Servers 130 may include a cloud server or a group of cloud servers. In some implementations, servers 130 may not be cloud-based (that is, platforms/applications may be implemented outside of a cloud computing environment) or may be partially cloud-based. Servers 130 may be configured to receive requests from a client device, process the requests, and send appropriate responses back to the client device. Servers 130 may include a database for storing data, platform content, and other relevant information.

The database(s) 152 may store backup files from the platform required to run software including, for example, specific operating systems, CPU types, or installed software libraries that enable the execution of various programs on client devices 110. The database(s) 152 may logically form a single unit or may be part of a distributed computing environment encompassing multiple computing devices that are located within their corresponding server, located at the same, or located at geographically disparate physical locations. For example, various information related to listings, filters, localization data, user preferences, or the like may be stored in the database(s) 152.

Network 150 can include, for example, any one or more of a local area network (LAN), a wide area network (WAN), the Internet, a mesh network, a hybrid network, or other wired or wireless networks. Further, network 150 can include, but is not limited to, any one or more of the following network topologies, including a bus network, a star network, a ring network, a mesh network, a star-bus network, tree or hierarchical network, and the like. Network 150 may be the Internet or some other public or private network. Client computing devices can be connected to network 150 through a network interface, such as by wired or wireless communication. The connections can be any kind of local, wide area, wired, or wireless network, including the network 150 or a separate public or private network.

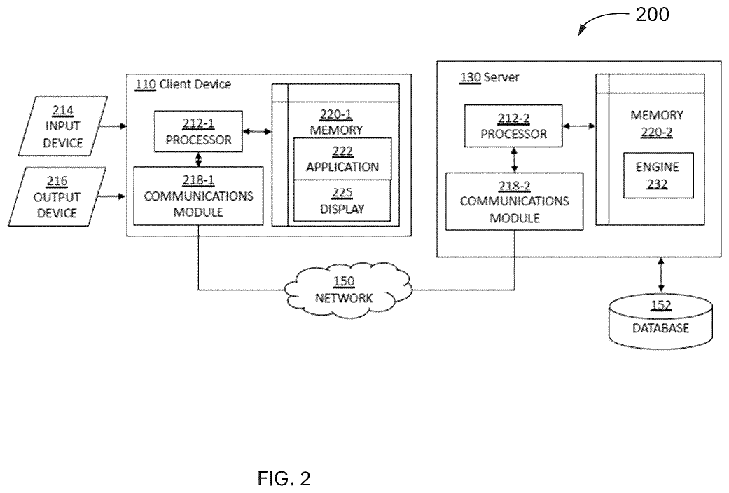

FIG. 2 is a block diagram 200 illustrating details of a client device 110 and server 130 used in a network architecture as disclosed herein (for example, architecture 100), according to some embodiments. Client device 110 and servers 130 are communicatively coupled over network 150 via respective communications modules 218-1 and 218-2 (hereinafter, collectively referred to as “communications modules 218”). Communications modules 218 are configured to interface with network 150 to transmit or receive information, such as user data, messaging history, user input data, and/or the like to other devices on the network 150. Communications modules 218 can be, for example, modems or Ethernet cards, and may include radio hardware and software for wireless communications (for example, via electromagnetic radiation, such as radiofrequency—RF—, near field communications—NFC—, Wi-Fi, and Bluetooth radio technology).

A user may interact with client device 110 via the input device 214 and the output device 216. Input device 214 may include a mouse, a keyboard, a pointer, a touchscreen, a wearable input device (for example, a haptics glove, a bracelet, a ring, an earring, a necklace, a watch, etc.), a microphone, a controller, a joystick, a virtual joystick, a camera, a touchscreen display that a user may use to interact with client device 110, or the like. In some implementations, the user provides search characters for a destination using the input device 214. In some embodiments, input device 214 may include cameras, microphones, and sensors, such as touch sensors, acoustic sensors, inertial motion units—IMUs—and other sensors configured to provide input data. Output device 216 may include a screen display (for example, an LCD display screen and/or LED display screen), a touchscreen, a speaker, a projector, holographic or augmented reality display (such as a heads-up display device or a head-mounted device), and/or the like.

In further examples, input device 214 and the output device 216 may include biometric components, motion components, environmental components, or position components, among a wide array of other components. For example, the biometric components include components to detect expressions (for example, hand expressions, facial expressions, vocal expressions, body gestures, or eye-tracking), measure biosignals (for example, blood pressure, heart rate, body temperature, perspiration, or brain waves), identify a person (for example, voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including electroencephalography (EEG) based BMIs, which record electrical activity in the brain using electrodes placed on the scalp, invasive BMIs, which used electrodes that are surgically implanted into the brain, and optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

In some embodiments, client devices 110 may include a headset or other wearable device (for example, a virtual reality or augmented reality headset or smart glass). In various implementations, client devices 110 can communicate over wired or wireless channels to distribute processing and/or share data. Architecture 100 can create, administer, and provide interaction modes for a shared artificial reality environment (for example, collaborative artificial reality environment) at client devices 110, such as for communication via XR or other communication elements. The interaction modes can include various modes for various audio conversation, textual input/output, communicative gestures, control modes, and other communicative interaction, etc., for each user of the client devices 110.

Client device 110 may also include a processor 212-1, configured to execute instructions stored in a memory 220-1, and to cause client device 110 to perform at least some operations in methods consistent with one or more embodiments and some operations are offloaded to a core processing component or server 130. Memory 220-1 may further include an application 222 and a display 225, configured to run in client device 110 and couple with input device 214 and output device 216. The application 222 may be downloaded by the user from servers 130 and may be hosted by servers 130. The application 222 includes specific instructions which, when executed by processor 212-1, cause operations to be performed according to methods described herein. In some embodiments, the application 222 runs on a platform, for example, an operating system (OS) installed in client device 110. In some embodiments, application 222 may run out of a web browser. In some embodiments, the processor is configured to control a graphical user interface (GUI) or display 225 for the user of one of client devices 110 accessing the server of the platform. Data and files associated with the application 222 may be stored in database(s) 152.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” In some implementations, the servers 130 can be used as part of a social network/platform implemented via the network 150. Processors 212 (for example, CPUs, GPUs, holographic processing units (HPUs), etc.) are configured to execute instructions stored in memories 220. The processors 212 can be a single processing unit or multiple processing units in a device or distributed across multiple devices (for example, distributed across two or more of client devices 110). The processors 212 can be coupled to other hardware devices, for example, with the use of an internal or external bus, such as a PCI bus, SCSI bus, wireless connection, and/or the like. The processors 212 can communicate with a hardware controller for devices, such as input device 214 and output device 216.

Memories 220 include one or more hardware devices for volatile or non-volatile storage, and can include both read-only and writable memory. For example, a memory can include one or more of random-access memory (RAM), various caches, CPU registers, read-only memory (ROM), and writable non-volatile memory, such as flash memory, hard drives, floppy disks, CDs, DVDs, magnetic storage devices, tape drives, and so forth. Memories 220 are not propagating signals divorced from underlying hardware; a memory is thus non-transitory. The memories 220 can include program memory that stores programs and software. The memories 220 can also include data memory that can include information to be provided to the program memory or any element of the network.

Memory 220-2 may include a search engine 232 which may share or provide features and resources to display 225, including multiple tools associated with text, image, or video collection and capture. These tools may support design applications that use images or pictures retrieved (for example, at application 222) for content rendering to a user of client device 110. This enables the platform to present listings, user reviews, and other relevant content effectively to the user. The user may access the search engine 232 through application 222, installed in a memory 220-1 of client device 110. Accordingly, application 222, including display 225, may be installed by servers 130 and perform scripts and other routines provided by servers 130 through any one of multiple tools. Servers 130 may include an application programming interface (API) layer, which controls applications in the client device 110. API layers may also provide tutorials to users of the client device 110 as to new features in the application 222. Search engine 232 may include one or more sets of machine-readable instruction modules that, when executed by processors 212, are configured to perform operations according to one or more aspects of embodiments described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, or distributed computing environments that include any of the above systems or devices, and/or the like.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

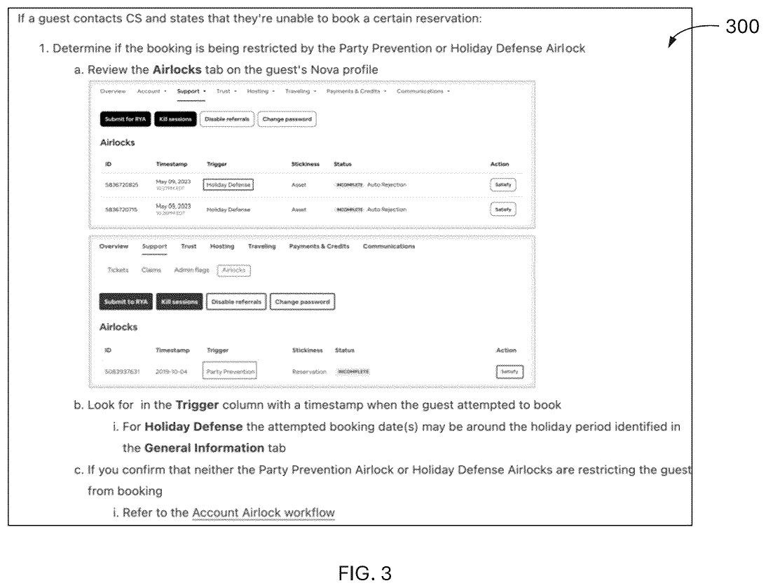

The current disclosure expedites the human-driven customer service experience by replacing the human-driven component with a large language model (LLM) and interpreter model. In response to a user query, a knowledge base comprising workflows and policies provides the basis for a human-driven response. In addressing the inefficiencies introduced by the human-driven response, an LLM may be used to help initiate a response in the absence of human interaction. The initiation of the LLM requires a set of prompts to progress the model. In prior embodiments, these prompts to advance the LLM may require a use and understanding of HTML. As depicted in FIG. 3, the human-driven customer service experience can include a scripted workflow 300 that a customer service representative may execute. In a current situation, a customer seeking assistance may call in to a customer service representative with a question that the customer service representative may be driven to answer. The efficiency and effectiveness of the response by the customer service representative is limited to understanding and experience of the customer service representative in addressing the underlying query. Existing knowledge such as workflows, exhibited in FIG. 3, are presented in a way that human agents can read and interpret with training and experience. For example, the workflow 300 may not be the first workflow retrieved for use depending on their level of experience.

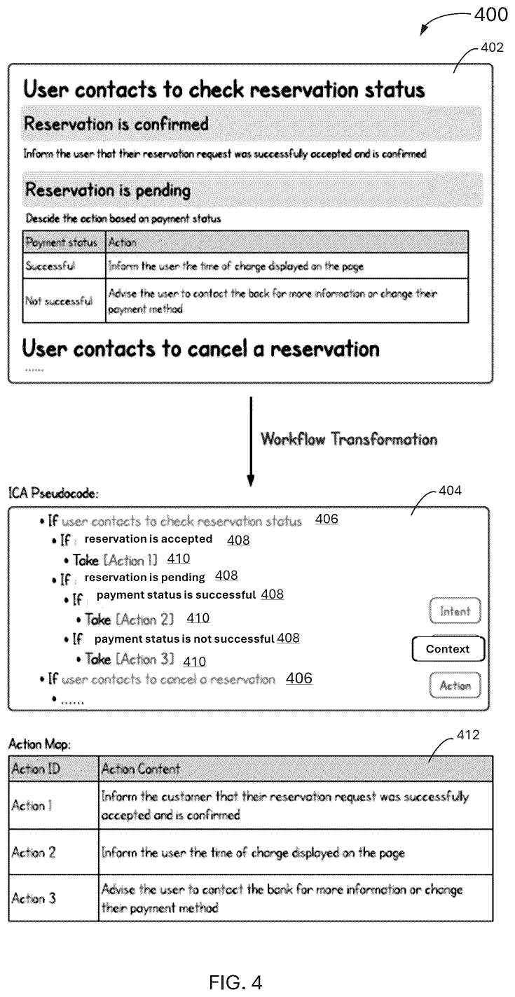

In an original syntax format, the knowledge base can comprise a rich text format, which can be difficult for an LLM to interpret. As depicted in FIG. 4, the process 400 in the current disclosure is initiated with a knowledge base 402 (workflow) associated with the experiences of a customer service representative. The formatting and structure of the knowledge base 402 directly impacts comprehension for both human agents and LLMs. The knowledge base 402 can be converted to an “Intent, Contexts, Actions” (ICA) syntax 404. The identified pattern of the ICA syntax 404 can define which workflows that human agents need to follow in order to respond to user queries. A typical workflow instructs when a user reaches out to a customer support agent with a certain “Intent” (I), based on the conditions; the “Contexts” (C) of the user issue, and what “Actions” (A) human agents should take. During a typical query, the customer service representative may analyze the scenario. In the case of the process 400 depicted in FIG. 4, the customer is seeking clarity on the status of a reservation. In response, the representative would progress through an analysis by determining if the reservation is confirmed or pending. Depending on the confirmed or pending status, an action item in the workflow 402 can be identified. The conversion from a workflow to the ICA pseudocode can be easier to create and maintain; in addition artificial intelligence and machine learning agents can more readily interpret the ICA syntax 404 (pseudocode).

The current disclosure transforms the workflow 402 into an ICA syntax 404 which is more readily understandable by the LLM. For example, in the ICA pseudocode 404. an intent 406 is identified. The intent 406 may be used to characterize the underlying purpose of the query. As depicted in FIG. 4, the intent 406 determined in the pseudocode 404 identifies the purpose of the query as 1) checking on the status of the reservation or 2) cancel a reservation. Based on the intent, the context 408 can define at least one condition that must be satisfied based on the respective identified intent 406. Based on the condition associated with a context 408 being satisfied or unsatisfied, a particular action 410 to provide to the customer can be identified. The action identifier (e.g., Action ID=Action 1, 2, 3, etc.) associated with the action in the pseudocode 404 corresponds to an action map 412. The action map 412 provides a list of the respective action items(s) to be executed in response to conditions being satisfied. The action map 412 can be arranged such that an action identifier is correlated to an action item. For example, “Action 1” correlates to “Inform the customer that their reservation request was successfully accepted and is confirmed”. In one aspect, the LLM only generates the action identifier; the content of the action (action item) can be queried from the action map 412. The approach to limiting the LLM result to the action identifier provides token size reduction of the prompt and the output for prediction of action item prediction, thereby decreasing latency.

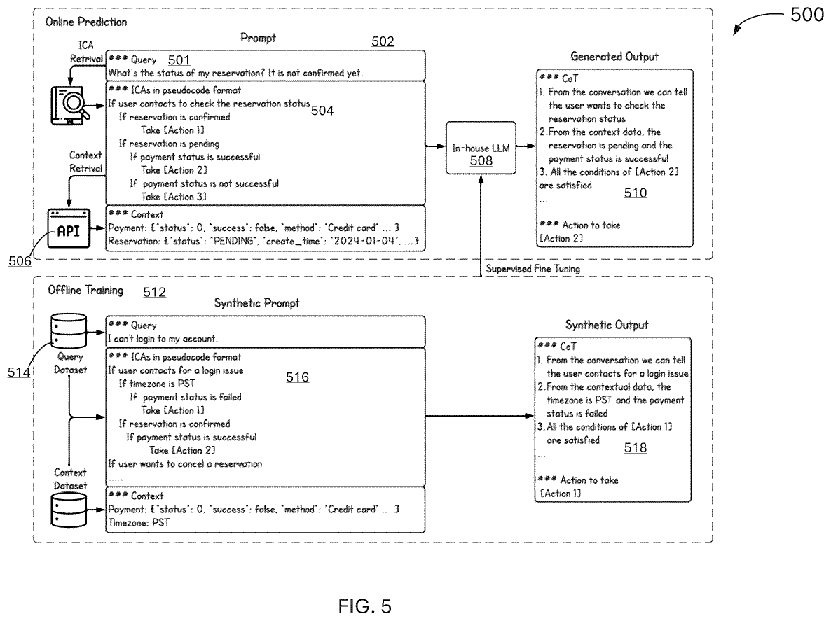

The determination of an action item by the LLM in response to a query, can be fine tuned by using training data. The process 500 as depicted in FIG. 5, can comprise an initial prediction 501 that generates an action item associated with a query 502. During the initial prediction 501, a query 502 can be received from a customer via the customer service platform. Similar to the depiction in FIG. 4, an ICA pseudocode 504 can be generated. In order to determine whether the associated conditions have been satisfied, an application program interface (API) 506 in communication with the user interface platform can perform a context retrieval to properly identify the associated conditions necessary to determine an action item. The API 506 can also determine if the conditions have indeed been satisfied, generating a contextual result The pseudocode 504 and contextual result can be passed to the LLM 508 to determine an action item. In a further aspect, the LLM can incorporate a Chain of Thought (CoT) reasoning model 510. The CoT model 510 enables an LLM by converting an answer to an initial question/prompt as input for the LLM. Further, the CoT model 510 is self-directed, so the CoT model 510 can initiate and manage its own thoughts without relying on a user's prompt sequence. The LLM 508 can then use a pattern established from the first question and answer to generate an answer for the second question and so forth. Integrating the CoT 510 with the ICA pseudocode 504 can reduce the computational requirements of the underlying processor making the processor more efficient. For example, integrating the CoT 510 with the ICA 504 can reduce average processing time by 10-15%, thus improving the efficiency and effectiveness of the processor.

The accuracy of the LLM 508 can be further improved with training data. In addition to the initial prediction process 502 of an action, training data can be generated and fed into the LLM 508 to fine tune the resultant action item. Synthesizing training data 512 from online or offline data sources (query datasets) 514 can be generated to provide a plurality of various situations that a customer may encounter. These various situations can be generated from randomly selected queries from the query dataset 514. These synthetic instances can be advance to define an appropriate solution for each randomly selected query. The training data comprising the random query progressing through the training ICA syntax 516 and training CoT model 518 can yield a synthetic action item output.

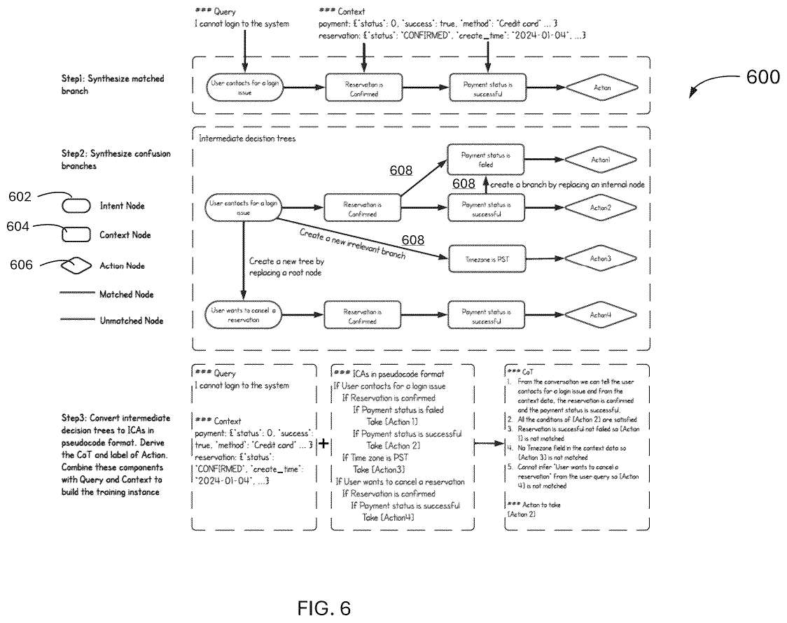

For the training data synthesis process 600, as depicted in FIG. 6, generating various action items from a randomly selected query can be represented as a nodal arrangement comprising nodes and branches. The nodal arrangement comprises a plurality of nodes: a root node 602 representing the condition on Intent; an internal node 604 representing conditions on Contexts, and the leaf nodes 606 representing the Actions. Evaluating the conditions at a context node can characterize the context node as either matched or unmatched. Upon determining a matched node (e.g., when conditions derived from the context are satisfied), an expansion of other nodal permutations can be generated. For example, several divergent (irrelevant) branches 608 can be generated to identify other viable action items or verify the invalidity (unmatched) of other action items. A divergent branch can comprise: within a particular branch, there exists more than one node that does not align with the user's query or associated context data. In one aspect, a node that is not aligned can comprise an unmatched node, wherein conditions derived from the context are unsatisfied. The generation of a divergent branch may be achieved either through the modification of certain nodes within the matched branch (if the node is the root node, a new tree will be created) or by incorporating an irrelevant branch. In finalizing the data synthesis, the totality of the progressions through each node combination, matched and unmatched can define a corresponding rationale for the CoT. This decision tree hierarchy can be converted with the pseudocode syntax, where the conditions of root node and internal nodes correspond to “if-else” clauses and actions of leaf nodes correspond to “then-do” blocks.

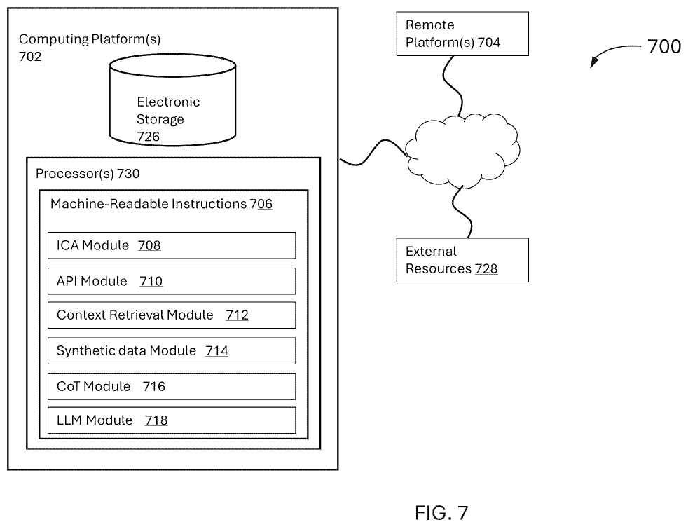

FIG. 7 is a block diagram illustrating an example system 700 (for example, representing both client and server) with which aspects of the subject technology can be implemented. The system 700 may be configured to improve searching on an online searchable platform, according to certain aspects of the disclosure. In some implementations, the system 700 may include one or more computing platforms 702. For example, the computing platform(s) 702 may be configured to execute software algorithm(s) to encode, compress, decompress, and reconstruct video/image data.

The computing platform(s) 702 can maintain or store data, such as in the electronic storage 726, including correlation, contextual data, and metadata used by the computing platform(s) 702. The computing platform(s) 702 may be configured to communicate with one or more remote platforms according to a client/server architecture, a peer-to-peer architecture, and/or other architectures. The remote platform 704 may be configured to communicate with other remote platforms via computing platform(s) 702 and/or according to a client/server architecture, a peer-to-peer architecture, and/or other architectures. Users may access the system 700 which may be hosting one or more of application(s), for example, via remote platform(s). In this way, the remote platform 704 can be configured to cause output of the system 700 on client device(s) of the remote platform 704 with enabled access (for example, based on analysis by the computing platform(s) 702 according to the stored data).

The computing platform(s) 702 may be configured by machine-readable instructions 706. The machine-readable instructions 706 may be executed by the computing platform(s) 702 to implement one or more instruction modules. The instruction modules may include computer program modules. The instruction modules being implemented may include one or more of an ICA module 708, API Module 710, context retrieval module 712, synthetic data module 714, CoT module 716, LLM module 718, and/or other instruction modules.

The ICA module 708 may be configured as an interpreter module that receives a knowledge base comprising policies, rules, and procedures that are associated with a workflow to address a query or inquiry. The ICA module 708 may be configured as an interpreter module that translates the knowledge base into a structured format of user intention, contextual information and an action format. In one aspect, the action format of the knowledge base can comprise an if <conditions> then <action> format. In a further aspect, the conditions are separated into the conditions that detect an intention from a user conversation.

The application programming interface (API) module 710 can be configured to integrate with the platform in which the user provides their query. The API module can be in communication with the platform the user is communicating with. For example, the user can enter a query in the front/end of the platform, the API module can be configured to extract query data that can be correlated to an intent parameter, a context parameter and an action parameter.

The context retrieval module 712 can be configured to identify conditions associated with the context or situation defined by the user query. The query solicited by the user can create a plurality of conditions that must be satisfied for the appropriate responsive action to be provided to the user. These conditions are context dependent, wherein the context is directly correlated to the query. As depicted in FIG. 6, the context of a reservation query can define a series of conditions requiring resolution before the appropriate action can be determined. The conditions can include payment status, payment type, reservation status, and reservation time. In a further aspect the context retrieval module 712 can be configured to determine if the configurations have been satisfied. In the event that the configurations have not been satisfied, the context retrieval module 712 can identify a supplemental set of conditions that can also be associated with the context that may lead to a different action item outcome from the LLM.

Synthetic data module 714 can be used to generate training data for fine tuning the LLM. In one aspect, the synthetic data module can be configured to randomly acquire user query and context data. A high quantity and variance of user queries and context data can yield a multitude of test cases; the synthetic data module can use these inputs to determine a plurality of potential actions. These plurality of potential actions can be supplied to the LLM to further refine the response to an actual query by a user.

Chain of Thought (CoT) module 716 can be integrated with the ICA module 708. The CoT module 716 can be coupled with the ICA module 708 to help convert the “if/then” coding syntax of the ICA into a more directly interpretable syntax by the LLM to determine a viable action. Integrating the CoT Module 716 with the ICA module 708 can reduce the computational requirements of the processor making the processor more efficient. For example, integrating the CoT module 716 with the ICA module 708 can reduce average processing time by 10-15%, thus improving the efficiency and effectiveness of the processor.

LLM module 718 can be configured to interpret the coding syntax of the ICA module 708, tuning data from the synthetic data module and rational syntax defined by the CoT Module 716 to determine an action item for the response. In an embodiment, the LLM can further be configured to operate in various environments such as a neural network. For example, the neural network configuration can be suited to integrate a node structure defined by the synthetic data sets generated by the synthetic data module 714.

In some implementations, the computing platform(s) 702, the remote platform 704, and/or the external resources 728 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 702, the remote platform 704, and/or the external resources 728 may be operatively linked via some other communication media.

A given remote platform may include client computing devices, such as the client device 110 or second client device, which may each include one or more processors configured to execute computer program modules (for example, the instruction modules). The computer program modules may be configured to enable an expert or user associated with the given remote platform to interface with the system 700 and/or external resources 728, and/or provide other functionality attributed herein to remote platform(s). By way of non-limiting example, a given remote platform and/or a given computing platform 702 may include one or more of a server, a desktop computer, a laptop computer, a handheld computer, a tablet computing platform, a NetBook, a Smartphone, a gaming console, and/or other computing platforms. The external resources 728 may include sources of information outside of the system 700, external entities participating with the system 700, and/or other resources.

Computing platform(s) 702 may include electronic storage 726, one or more processors 730, and/or other components. Computing platform(s) 702 may include communication lines, or ports to enable the exchange of information with a network and/or other computing platforms. Illustration of the computing platform(s) 702 in FIG. 7 is not intended to be limiting. The computing platform(s) 702 may include a plurality of hardware, software, and/or firmware components operating together to provide the functionality attributed herein to the computing platform(s) 702. For example, the computing platform(s) 702 may be implemented by a cloud of computing platforms operating together as the computing platform(s) 702.

Electronic storage 726 may comprise non-transitory storage media that electronically stores information. The electronic storage media of electronic storage 726 may include one or both of system storage that is provided integrally (that is, substantially non-removable) with computing platform(s) 702 and/or removable storage that is removably connectable to computing platform(s) 702 via, for example, a port (for example, a USB port, a firewire port, etc.) or a drive (for example, a disk drive, etc.). Electronic storage 726 may include one or more of optically readable storage media (for example, optical disks, etc.), magnetically readable storage media (for example, magnetic tape, magnetic hard drive, floppy drive, etc.), electrical charge-based storage media (for example, EEPROM, RAM, etc.), solid-state storage media (for example, flash drive, etc.), and/or other electronically readable storage media. Electronic storage 726 may include one or more virtual storage resources (for example, cloud storage, a virtual private network, and/or other virtual storage resources). Electronic storage 726 may store software algorithms, information determined by processor(s) 730, information received from computing platform(s) 702, information received from remote platform(s) 704, and/or other information that enables computing platform(s) 702 to function as described herein.

Processor(s) 730 may be configured to provide information processing capabilities in computing platform(s) 702. As such, processor(s) 730 may include one or more of a digital processor, an analog processor, a digital circuit designed to process information, an analog circuit designed to process information, a state machine, and/or other mechanisms for electronically processing information. Although processor(s) 730 is shown in FIG. 7 as a single entity, this is for illustrative purposes only. In some implementations, processor(s) 730 may include a plurality of processing units. These processing units may be physically located within the same device, or processor(s) 730 may represent processing functionality of a plurality of devices operating in coordination. Processor(s) 730 may be configured to execute modules 708, 710, 712, 714, 716, and/or 718, and/or other modules. Processor(s) 730 may be configured to execute modules 708, 710, 712, 714, 716, and/or 718, and/or other modules by software; hardware; firmware; some combination of software, hardware, and/or firmware; and/or other mechanisms for configuring processing capabilities on processor(s) 730. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 708, 710, 712, 714, 716, and/or 718 are illustrated in FIG. 7 as being implemented within a single processing unit, in implementations in which processor(s) 730 includes multiple processing units, one or more of modules 708, 710, 712, 714, 716, and/or 718 may be implemented remotely from the other modules. The description of the functionality provided by the different modules 708, 710, 712, 714, 716, and/or 718 described below is for illustrative purposes, and is not intended to be limiting, as any of modules 708, 710, 712, 714, 716, and/or 718 may provide more or less functionality than is described. For example, one or more of modules 708, 710, 712, 714, 716, and/or 718 may be eliminated, and some or all of its functionality may be provided by other ones of modules 708, 710, 712, 714, 716, and/or 718. As another example, processor(s) 730 may be configured to execute one or more additional modules that may perform some or all of the functionality attributed below to one of modules 708, 710, 712, 714, 716, and/or 718.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

### Hardware Overview

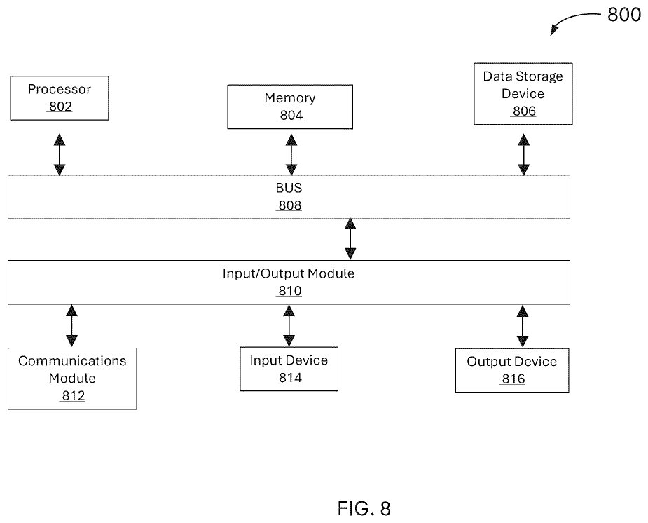

FIG. 8 is a block diagram illustrating an exemplary computer system 800 with which the client and server of FIGS. 1-7, and method(s) described herein can be implemented. In certain aspects, the computer system 800 may be implemented using hardware or a combination of software and hardware, either in a dedicated server, or integrated into another entity, or distributed across multiple entities. Computer system 800 may include a desktop computer, a laptop computer, a tablet, a phablet, a smartphone, a feature phone, a server computer, or otherwise. A server computer may be located remotely in a data center or be stored locally.

Computer system 800 includes a bus 808 or other communication mechanism for communicating information, and a processor 802 (for example, processors 212) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, for example, code that constitutes processor firmware, a protocol stack, a database management system, an operating system, or a combination of one or more of them stored in an included memory 804 (for example, memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, for example, one or more modules of computer program instructions encoded on a computer-readable medium for execution by, or to control the operation of, the computer system 800, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 (for example, communications module 218) include networking interface cards, such as Ethernet cards and modems. In certain aspects, input/output module 810 is configured to connect to a plurality of devices, such as an input device 814 and/or an output device 816. Exemplary input devices 814 include a keyboard and a pointing device, for example, a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, for example, visual feedback, auditory feedback, or tactile feedback; and input from the user can be received in any form, including acoustic, speech, tactile, or brain wave input. Exemplary output devices 816 include display devices, such as an LCD (liquid crystal display) monitor, for displaying information to the user.

According to one aspect of the present disclosure, the client device and server can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, for example, a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of digital data communication, for example, a communication network. The communication network (for example, network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (that is, each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method, performed by at least one processor, for tuning a Large Language Model (LLM) in a platform, the method comprising:
receiving a query from a user;
in response to the query, identifying a workflow of a plurality of workflows;
extracting from the workflow: at least one intent parameter, at least one context parameter, and at least one action parameter;
providing the at least one intent parameter, the at least one context parameter, and the at least one action parameter to the LLM structured in a coding syntax for use by the LLM;
retrieving contextual data from an application programming interface (API) associated with the query;
tuning the LLM, wherein tuning the LLM comprises training the LLM with synthetic training data; and
providing an action item to a user via the LLM.

2. The computer-implemented method of claim 1, wherein the coding syntax defines the action parameter with an associated action identifier, and generating an action map comprising the action identifier correlated to the action item.

3. The computer-implemented method of claim 2, wherein providing the action item to the user via the LLM comprises reducing latency associated with the at least one processor by providing the action identifier associated with the action item such that a token size of the action item is reduced.

4. The computer-implemented method of claim 1, wherein extracting the at least one intent parameter, the at least one context parameter, and the at least one action parameter comprises identifying the at least one intent parameter, the at least one context parameter, and the at least one action parameter based on a knowledge base associated with the query.

5. The computer-implemented method of claim 1, wherein training the synthetic data comprises:
randomly selecting user query data and context data;
determining correlation between the user query data and context data;
generating a decision tree based on the correlation; and
converting the decision tree into the coding syntax.

6. The computer-implemented method of claim 1, wherein the coding syntax further comprises chain of thought (CoT) rationale, wherein the CoT rationale defines a progression through a plurality of matched nodes resulting in the action item.

7. The computer-implemented method of claim 6, wherein the progression through the plurality of matched nodes comprises determining a match between the at least one intent parameter and the at least one context parameter.

8. The computer-implemented method of claim 1, further comprising retrieving the contextual data determining a contextual result wherein at least one condition derived from the contextual data has been satisfied, and providing the contextual result to the LLM.

9. The computer-implemented method of claim 1, wherein the coding structure syntax is a pseudocode.

10. A system for tuning an LLM on a platform, the system comprising:
one or more processors; and
a memory storing instructions which, when executed by the one or more processors, cause the system to:
receive a query from a user;
in response to the query, identifying a workflow of a plurality of workflows;
extract from the workflow: at least one intent parameter, at least one context parameter, and at least one action parameter;
provide the at least one intent parameter, the at least one context parameter, and the at least one action parameter to the LLM structured in a coding syntax for use by the LLM;
retrieve contextual data from an application programming interface (API) associated with the query;
tune the LLM, wherein tuning the LLM comprises training the LLM with synthetic training data; and
provide an action item to a user via the LLM.

11. The system of claim 10, wherein the coding syntax defines the action parameter with an associated action identifier, and generating an action map comprising the action identifier correlated to the action item.

12. The system of claim 11, wherein instructions causing the system to provide the action item to the user via the LLM comprises reducing latency associated with the one or more processor by providing the action identifier associated with the action item such that a token size of the action item is reduced.

13. The system of claim 10, wherein instructions causing the system to extract the at least one intent parameter, the at least one context parameter, and the at least one action parameter comprises identifying the at least one intent parameter, the at least one context parameter, and the at least one action parameter based on a knowledge base associated with the query.

14. The system of claim 10, wherein training the synthetic data comprises:
randomly selecting user query data and context data;
determining correlation between the user query data and context data;
generating a decision tree based on the correlation; and
converting the decision tree into the coding syntax.

15. The system of claim 10, wherein the coding syntax further comprises a chain of thought (CoT) rationale, wherein the CoT rationale defines a progression through a plurality of matched nodes resulting in the action item.

16. The system of claim 15, wherein the progression through the plurality of matched nodes comprises determining a match between the at least one intent parameter and the at least one context parameter.

17. The system of claim 10, wherein the instructions are further configured to, in response to retrieving the contextual data, determine a contextual result wherein at least one condition derived from the contextual data has been satisfied, and provide the contextual result to the LLM.

18. A non-transitory computer-readable medium storing a program for tuning a Large Language Model (LLM) on a platform, which when executed by a computer, configures the computer to:
receive a query from a user;
in response to the query, identify a workflow of a plurality of workflows;
extract from the workflow: at least one intent parameter, at least one context parameter, and at least one action parameter;
provide the at least one intent parameter, the at least one context parameter, and the at least one action parameter to the LLM structured in a coding syntax for use by the LLM;
retrieve contextual data from an application programming interface (API) associated with the query;
in response to retrieving the contextual data, determine a contextual result wherein at least one condition derived from the contextual data has been satisfied, and provide the contextual result to the LLM;
tune the LLM, wherein tuning the LLM comprises training the LLM with synthetic training data; and
provide an action item to a user via the LLM.

19. The non-transitory computer-readable medium of claim 18, wherein training the synthetic data comprises:
randomly selecting user query data and context data;
determining correlation between the user query data and context data;
generating a decision tree based on the correlation; and
converting the decision tree into the coding syntax.

20. The non-transitory computer-readable medium of claim 18, wherein the coding syntax further comprises a chain of thought (CoT) rationale, wherein the CoT rationale defines a progression through a plurality of matched nodes resulting in the action item.
